(19) United States
(12) Patent Application Publication
(10) Pub. No.: US 2023/0132882 A1
(43) Pub. Date: May 4, 2023

(54) METHOD AND APPARATUS FOR HONEY BEE MITE REMOVAL

(71) Applicant: Dialectx Technologies, West Hollywood, CA (US)

(72) Inventors: Joseph Farrell, West Hollywood, CA (US); Mitch Muller, Albany, CA (US); Carissa Sinclair, Alpha, NJ (US); Brant DeBow, Bristol, TN (US)

(73) Assignee: Dialectx Technologies, West Hollywood, CA (US)

(21) Appl. No.: 17/515,310

(22) Filed: Oct. 29, 2021

(51) Int. Cl. A01K 51/00

(52) U.S. Cl. CPC A01K 51/00

(57) ABSTRACT

A honey bee mite removal device includes a chamber having a one-way entry gate opposing an exit gate. An electronics puck is positioned within the chamber as well as a fondant to entice honey bees to enter the chamber through the one-way entry gate. There is also a dusting assembly within the chamber adjacent to the exit gate to dispense dusting powder onto the honey bees so that the honey bees groom themselves dislodging any mites that are attached to the honey bees.

### BACKGROUND—FIELD OF THE INVENTION

This invention relates to a method and apparatus for honey bee mite removal, and more particularly, to a method and apparatus adapted to expose honey bees to a protective formulation for dislodging mites from honey bees and protecting honey bee colonies.

### BACKGROUND—DESCRIPTION OF RELATED ART

Honey bees can generally be described as flying insects that form colonial nests for shelter and for the storage of honey. A honey bee colony generally comprises a single fertile queen bee, a few thousand fertile male drone bees, and tens of thousands of sterile female worker bees. Honey bees have proven to be very beneficial, as they are the only natural source of beeswax and honey, and perhaps most importantly, they pollinate fruits and vegetables that are vital to the human food supply. As such, honey bees have been domesticated all over the world, with the Apis mellifera species representing the primary species maintained by beekeepers.

Honey bees are prone to invasion in the form of mites, which can be divided into three groups: parasites, phoretic mites, and house guests. The most dangerous parasitic mites include Varroa jacobsoni, Acarapis woodi, and Tropilaelaps clareae, which can cause serious disease in honey bees and honey bee colonies. Phoretic mites are generally less harmful, as they prefer flowers and use honey bees for transport from one plant to another and only arrive accidentally in a beehive. Among the many house guests are species that feed on old provisions and a few species that feed on other mites. Mites rarely feed on stored pollen in active hives, although large numbers of pollen-feeding mites are often found in stored honeycombs.

Perhaps the most threatening of all mites is the varroa mite, which pose the greatest threat to honey bee populations worldwide. Varroa mites attack both the bee and their brood, threatening to wipe out entire colonies and disrupt the food chain on a global scale. In the past few decades, varroa mites, which are traditionally native to specific continents, have begun to spread around the world and pose a threat to the worldwide honey bee population. Beekeepers are alert to the dangers these mites pose; however, given the rate at which people move around earth and the laxity of customs officials in most countries, these mites are as ubiquitous as their hosts.

To combat varroa mites, beekeepers will employ pesticides and other invasive and toxic formulations. While these methods can be effective in the short-term at curbing the spread of varroa mites, they are also very destructive to honey bees and their environment. Furthermore, varroa mites have shown a startling ability to develop rapid resistance to synthetic pesticides. Therefore, a need exists for a non-invasive, non-toxic, low-resistance method and apparatus for effectively removing mites from honey bees. The present invention accomplishes these needs.

### BRIEF SUMMARY OF THE INVENTION

The present invention comprises a non-invasive method and apparatus for effectively removing mites from honey bees, thereby preventing them from infecting their colonies. This is accomplished through a chamber having a one-way entry gate and an exit gate. A fondant positioned within the chamber entices the honey bees to enter through the one-way entry gate, while a dusting assembly is positioned adjacent to the exit gate and is configured to distribute a dusting powder on the honey bees as they exit. The dusting powder will act as a deterrent, causing the bees to groom themselves, thus detaching the mites from the bees during the grooming process.

These and other objectives of the present invention will become obvious to those of ordinary skill in the art after reading the following detailed description of the preferred embodiments. It is to be understood that the foregoing general description and the following detailed description are exemplary, and are intended to provide further explanation of the invention as claimed.

### BRIEF DESCRIPTION OF THE DRAWINGS

Embodiments of this invention may best be understood by referring to the following description and accompanying drawings that are used to illustrate the invention. In the drawings:

FIG. 1 is a top perspective view of the present invention;

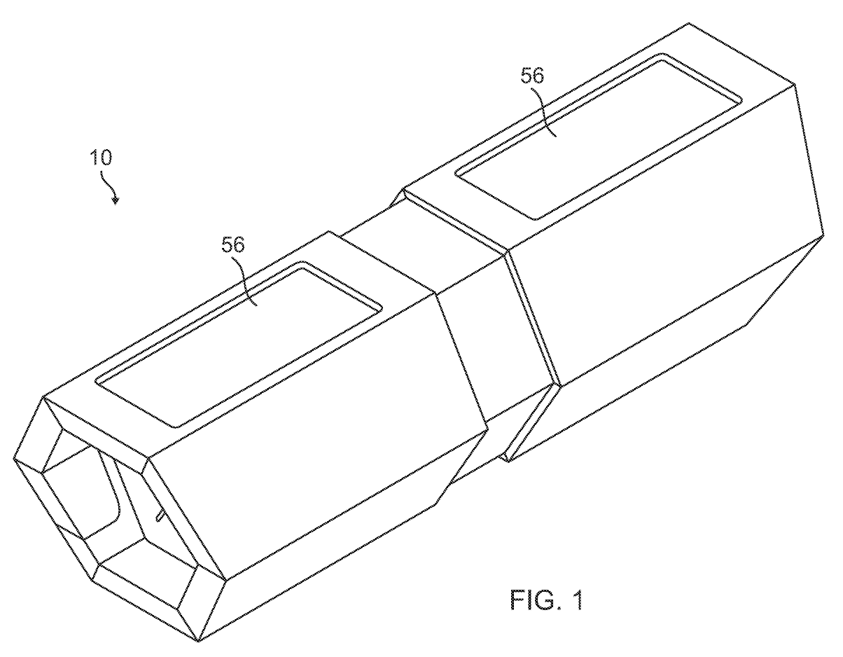

FIG. 2 is a top perspective view thereof with access door open, showing the internal components of the chamber;

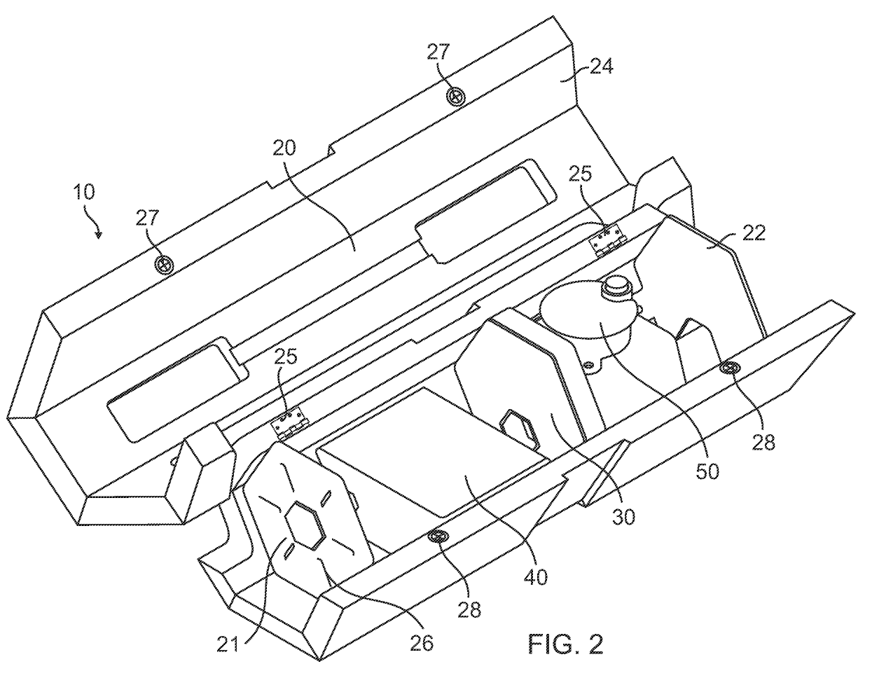

FIG. 3 is a bottom perspective view of the present invention showing the mesh floor;

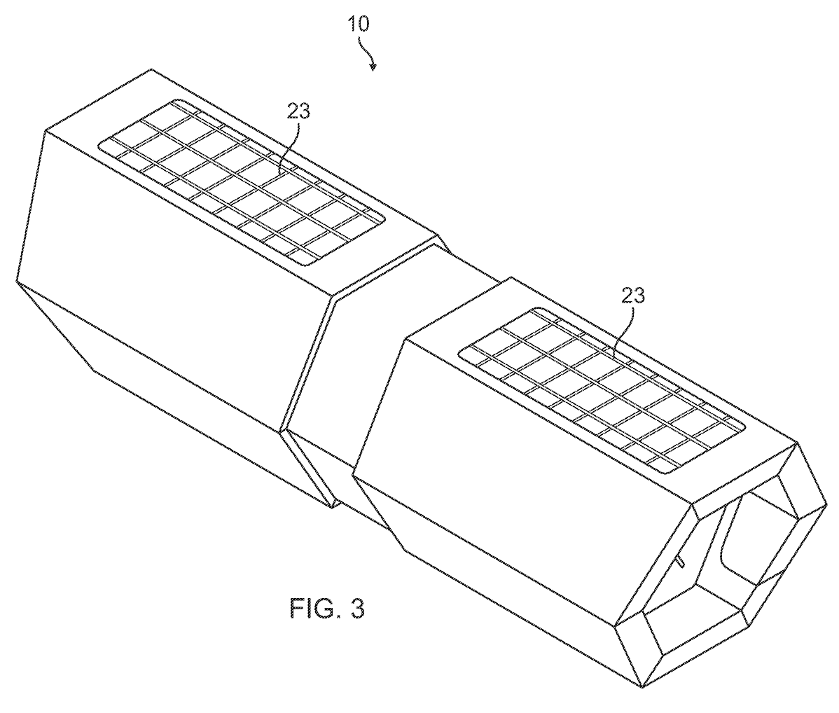

FIG. 4 is an exploded perspective view of the dusting assembly and electronics puck;

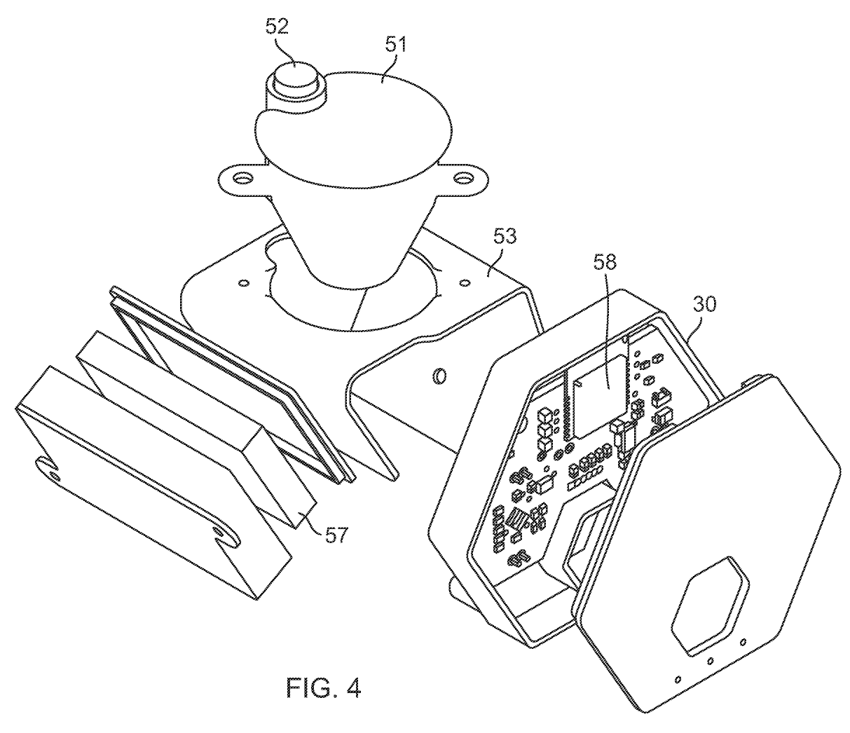

FIG. 5 is a side view of the dusting assembly and electronics puck;

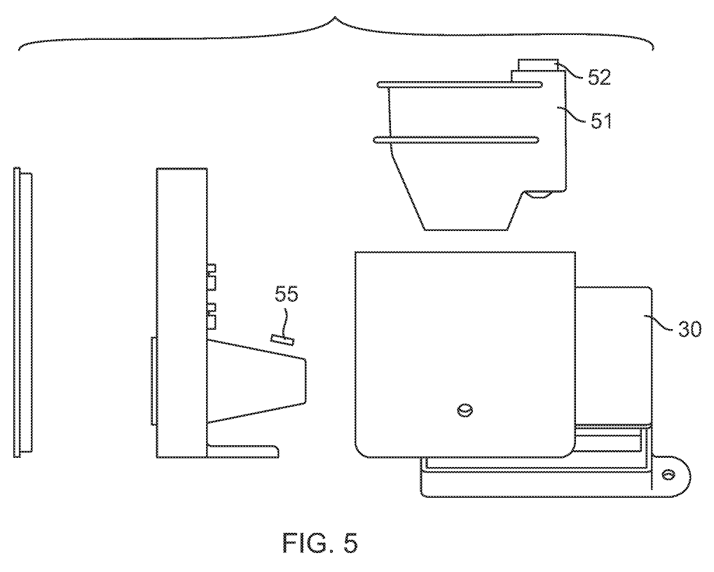

FIG. 6 is a top view thereof;

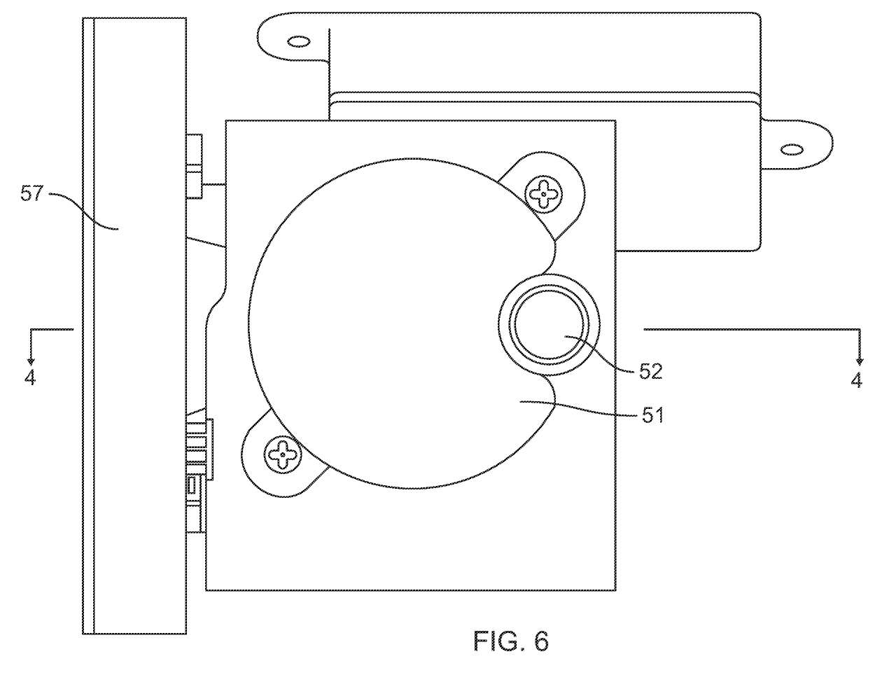

FIG. 7 is a cross-sectional view of the dusting assembly and electronics puck;

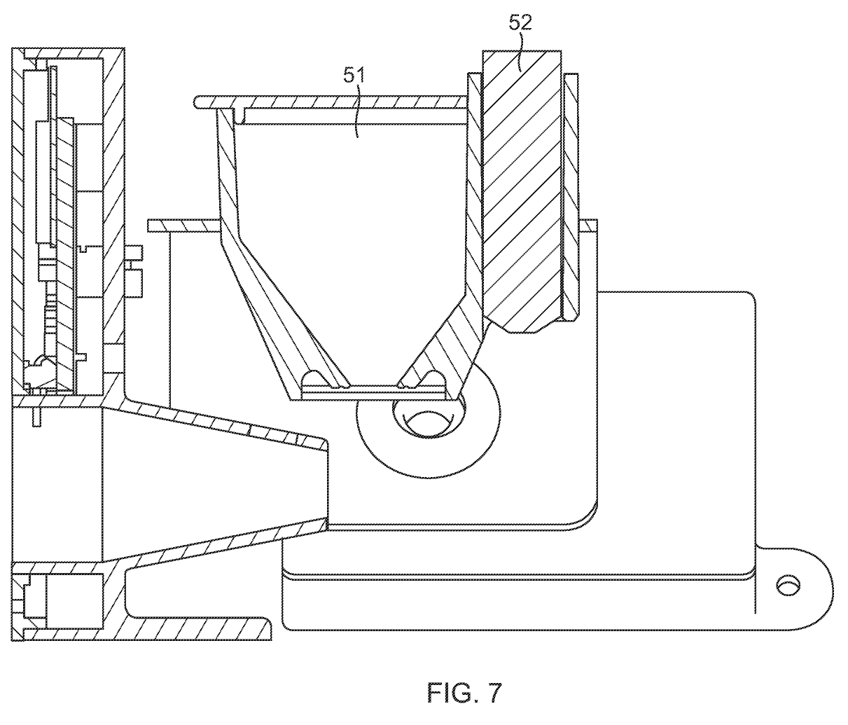

FIG. 8 is a perspective view of the dusting assembly and electronics puck;

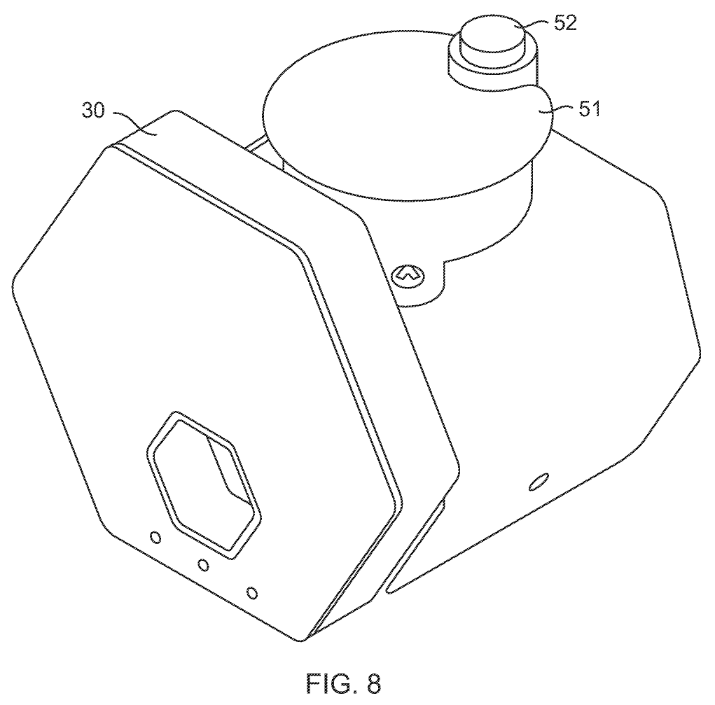

FIG. 9 is a perspective view of the dusting assembly and electronics puck showing the vibration motor and mesh disc;

FIG. 10 is a perspective view of the dusting assembly and electronics puck; and

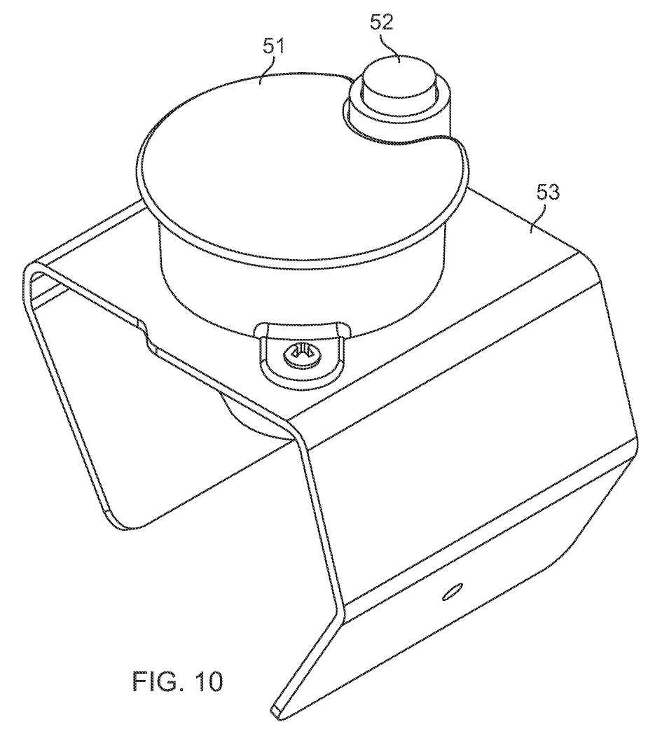

FIG. 11 is an illustration of the mobile application and wireless connectivity.

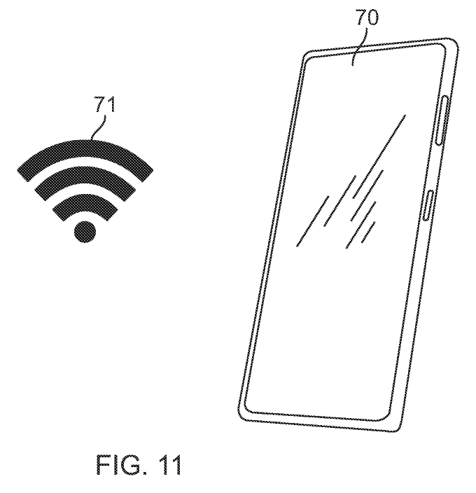

### DETAILED DESCRIPTION

Embodiments of the present invention are described herein in the context of a honey bee mite removal device. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

The present invention 10 is directed to an apparatus for effectively removing mites from honey bees. This is accomplished through a chamber 20 having a one-way entry gate 21 and an exit gate 22, with an electronics puck 30 positioned between them. Fondant 40 is used to entice the honey bees to enter through the one-way entry gate 21, while a dusting assembly 50 is positioned adjacent to the exit gate 22 and is configured to distribute a dusting powder 60 to the honey bees. The dusting powder 60 will act as a deterrent, encouraging the bees to groom themselves and thus causing mites to become dislodged during the grooming process.

The chamber 20 comprises an enclosed area with one entry and one exit 21, 22 defined by a proximal side and a distal side, respectively. The chamber 20 is formed from a baseboard assembly, a roof assembly, a one-way entry gate 21 on the proximal side, and an exit gate 22 on the distal side. The baseboard assembly and roof assembly each comprise a plurality of panels fixedly attached to one another and are adapted to connect to form the top and bottom of the chamber 20. The entry and exit gates 21, 22 are of critical importance to the operation of the device 10 and must never be obstructed or the honey bees will not enter the device 10. Furthermore, the chamber 20 must be adequately ventilated, as honey bees avoid moisture and unfavorable temperatures.

In a preferred embodiment, the baseboard and roof assembly comprise three panels of equal width, each having a 120-degree angle between them. As such, when the baseboard assembly and roof assembly are combined, the chamber 20 has a generally hexagonal shape, where all six sides are congruent. In a preferred embodiment, the panels are formed from a light and durable wood, such as cedar or cypress. In an alternative embodiment, the roof assembly further comprises eaves on the outermost panels, wherein the outermost panels of the roof assembly will hang over the outermost panels of the baseboard assembly when combined.

In a preferred embodiment, the roof assembly further comprises an access door 24 configured to provide access to the chamber 20 for maintenance. The access door 24 further comprises a hinge 25, wherein the access door 24 is rotatably attached to the roof assembly by said hinge 25. When opened, access to the chamber 20 is provided, and when closed, the chamber 20 is sealed with only one entry and exit means 21, 22. Here, the chamber 20 can be easily opened and serviced with minimal disruption to the bees. The access door 24 further comprises a pair of magnets 27 configured to magnetically attach to a pair of opposing magnets 28 positioned on the chamber 20, where the magnets 27, 28 will keep the access door 24 in a closed position.

The baseboard assembly further comprises a mesh floor 23 comprising a plurality of apertures. The mesh floor 23 is configured to allow mites and excess dusting powder 60 to fall from the device 10 as the honey bees groom themselves. More specifically, the mesh floor 23 prevents mites from reattaching to the honey bees and further prevents powder build-up in the device 10. Here, the size of the apertures of the mesh floor 23 are configured to permit mites and powder to exit, but are too small to permit bees to enter and exit the device 10. In a preferred embodiment, the size of the apertures of the mesh floor 23 range between 100-500 microns.

The one-way entry gate 21 is a panel positioned at the proximal side of the device 10 and provides a means for entry into the chamber 20. More specifically, the entry gate 21 is large enough to permit honey bees to enter, but small enough to prevent larger insects from entering. Furthermore, the one-way entry gate 21 is configured to only permit ingress into the device 10. This is accomplished through one or a plurality of conically-shaped apertures at its center, wherein the base of the cone is positioned at the outside of the chamber 20 and the apex of the cone is positioned inside the chamber 20. The conical shape of the aperture will encourage honey bees to enter the chamber 20 by funneling them inward. The entry gate 21 is formed of a durable plastic material selected for longevity and resistance to environmental deterioration and repellant to harmful microorganisms. In a preferred embodiment, the entry gate 21 further comprises ultraviolet paint 26 surrounding the conically-shaped aperture at its center, where the ultraviolet paint 26 has a shape or pattern (ex. Bullseye) that entices honey bees into the entry gate 21.

The exit gate 22 is a panel positioned at the distal side of the device 10 opposite the one-way entry gate 21 and provides a means for exit out of the chamber 20 through an exit aperture. The exit gate 22 is positioned adjacent to the dusting assembly 50, with the exit aperture positioned such that honey bees are encouraged to exit after dusting and grooming. In the preferred embodiment, the exit gate 22 is positioned at the base of the panel, adjacent to the mesh floor 23. The exit gate 22 is formed of a durable plastic material selected for longevity and resistance to environmental deterioration and repellant to harmful microorganisms.

The fondant 40 is positioned within the chamber near the entry gate 21 and is configured to entice honey bees toward the entry gate 21 and into the device 10. The fondant 40 comprises a mixture of essential oils, glycerin, sugar, and water and has a generally solid consistency. In an alternative embodiment, the fondant 40 further comprises corn syrup. In yet a further alternative embodiment, the fondant 40 further comprises peppermint and lemongrass. While the fondant 40 primarily functions as a reward for entering the device 10, it further operates as a food source for honey bees. Once the honey bees learn of the food source in the device 10, they will return to their hive and signal to the other foraging honey bees of the location of the food source, thereby attracting more bees.

The electronics puck 30 is positioned adjacent to the fondant 40 and dusting assembly 50 and operates as a barrier between the entry and exit gates 21, 22, functionally dividing the chamber 20 into two sections. Here, the first section is functionally limited to feeding via the fondant 40 while the second section is functionally limited to grooming. The electronics puck 30 comprises a conically-shaped apertures at its bottom, wherein the base of the cone is positioned toward the entry gate 21 and the apex of the cone is positioned toward the exit gate 22. The conical shape of the aperture will encourage honey bees to exit the first section by funneling them toward the second section.

The electronics puck 30 comprises an electronic circuit 58 for controlling the device 10. The electronics puck 30 further comprises a plurality of sensors 55 configured to detect one or a plurality of bees as they pass from the chamber 20 and through said electronics puck 30. In the preferred embodiment, sensors 55 include: visual sensors, infrared sensors, auditory sensors, pressure sensors, or any other sensors 55 configured to detect the presence and quantity of bees within the chamber 20. More specifically, these sensors 55 will monitor and record bee and device activity, fondant usage, dusting powder usage, and other information relating to the operation and maintenance of the present invention. Furthermore, these sensors 55 are configured to activate the vibration motor 52 if certain criteria are met, such as if one or a plurality of honey bee pass are detected within the electronics puck 30 or dusting assembly 50. In the preferred embodiment, the electronics puck 30 is in electrical communication with a plurality of solar panels 56 and battery 57 for powering the electronic circuit 58 and vibration motor 52.

The electronics puck 30 comprises a means of wireless communication (WiFi, Bluetooth, etc.) for communicating with an external mobile application (App) 70. Specifically, the electronics puck 30 wirelessly communicates data 71 with the App 70, exchanging data comprising usage data, range of protection, quantity of dusting powder, fondant replacement warnings, dusting powder refill warnings, and refill recommendations such that mites do not become resistant to the dusting powder 60. For example, fondant 40 is ideally replaced every 30 days, and as such, the present invention will monitor the fondant usage levels and notify the user when the fondant 40 must be replaced, but will always suggest replacement after 30 days have passed. Firmware updates are available for the electronics puck 30 through over-the-air updates or by wirelessly connecting to the mobile application 70.

The dusting assembly 50 is positioned adjacent to the electronics puck 30 and exit gate 22, and is in electrical communication with the electronics puck 30. The dusting assembly 50 comprises a hopper 51, a filter 54, a vibration motor 52, and a hopper saddle 53 configured to apply dusting powder 60 to the honey bees. When activated, the vibration motor 52 will dispense a dose of dusting powder 60 to the bees located within the dusting assembly 50.

The hopper 51 is configured to retain the dusting powder 60 and has a generally funnel-shape. More specifically, the shape of the hopper 51 is configured to store and promote the delivery of dusting powder 60 through gravitational forces. The hopper 51 can be refilled by pouring dusting powder 60 directly into the hopper 51 and further comprises a lid configured to seal the hopper 51, protecting the dusting powder 60 from outside particulate or other unwanted materials.

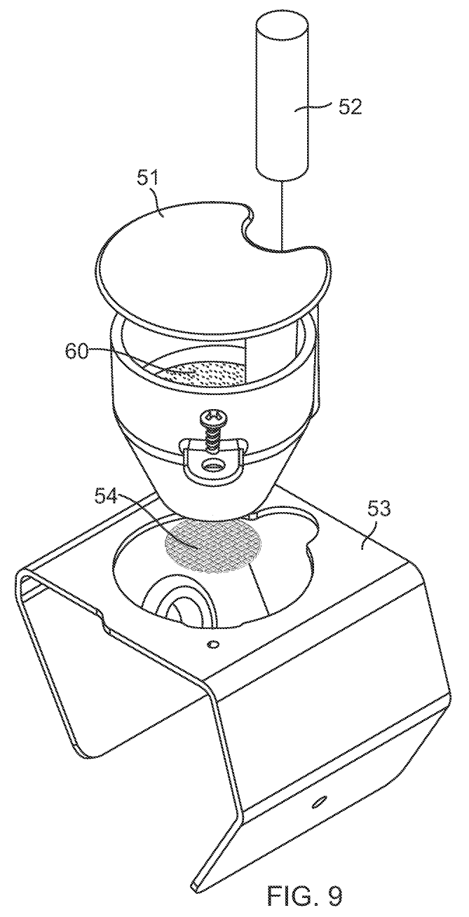

The filter 54 is positioned adjacent to the hopper 51 and is configured to receive dusting powder 60 from the hopper 51 and provide an even distribution of dusting powder 60 onto the honey bees. Furthermore, the filter 54 will prevent clumping of the dusting powder 60. In the preferred embodiment, the filter 54 is in the form of a mesh disc (see FIG. 9). In an alternative embodiment, the filter 54 is a grate. In a further alternative embodiment, the filter 54 is omitted, and the hopper 51 dispenses dusting powder 60 directly.

The vibration motor 52 is in material communication with the hopper 51 and is configured to agitate the hopper 51, encouraging the dispensation of dusting powder 60. More specifically, when the vibration motor 52 is activated by the electronics puck 30, it will agitate the hopper 51, causing the dusting powder 60 to fall from the hopper 51, through the filter 54, and onto the bees. The vibration motor 52 duration and intensity can be adjusted through a mobile application 70 to increase or decrease the amount of dusting powder 60 released from the dusting assembly 50, with longer duration and higher intensity increasing the amount of dusting powder 60 released, and shorter duration and lower intensity decreasing the amount of dusting powder 60 released. In the preferred embodiment, the dusting assembly 50 will dispense between 1-10 milligrams of dusting powder 60. In a further exemplary embodiment, the dusting assembly 50 will dispense between 3-5 milligrams of dusting powder 60. The vibration motor 52 is isolated from the rest of the device 10 through the hopper saddle 53 to reduce noise and vibration. Dampening foam, rubber, or other materials can be used to further isolate this vibration and noise from the device 10.

The hopper saddle 53 is configured to retain the hopper 51, vibration motor 52, and filter 54, while providing a grooming area for the honey bees to naturally groom themselves after dusting powder 60 is dispensed. The hopper saddle 53 has a generally upside-down ‘U’ shape, with the hopper 51, vibration motor 52, and filter 54 retained in the air while the honey bees groom themselves underneath (See FIG. 9). The hopper saddle 53 is aligned with the aperture of the electronics puck 30 to receive honey bees as they enter the second section of the chamber 20. The hopper saddle 53 is formed of a durable material selected for longevity and resistance to environmental deterioration and repellant to harmful microorganisms.

The dusting powder 60 is a powder mixture comprising cinnamon, lemongrass, rosemary, or wax of varying percentages, with the essential oils capable of repelling mites from the honey bees. The dusting powder 60 is designed to mimic the size and weight of pollen, and as such, will have a size ranging between 100 microns to 300 microns. The weight ratio of the wax to other ingredients in the dusting powder 60 ranges between .90:1 to .95:1. Furthermore, different dusting powder compositions will be used for varying seasons, and rotation dusting powder compositions will also prevent mites from generating a tolerance to the dusting powder 60. Relative proportions of the ingredients can be adjusted to optimize results based upon the stipulated design factors and desired characteristics and qualities of the end-user. The chart below provides three exemplary embodiments of dusting powder 60 compositions:

| | | |
|---|---|---|
| Formula 1 - Fall | Formula 2 - Summer | Formula 3 - Spring |
| Rosemary (10%) | Cinnamon (5%) | Lemongrass (5%) |
| Wax (90%) | Wax (95%) | Wax (95%) |

When the honey bees come into contact with the dusting powder 60, the varroa mites may detach voluntarily or forcefully. Any mites that do not detach voluntarily are removed during the grooming process. Any mites which attempt to attach to the honey bees after dusting will be prevented from doing so, as the dusting powder 60 creates a slippery surface and does not allow the mites to attach. Furthermore, the mesh floor 23 of the device 10 will eject most mites that fall from the bees during grooming, further preventing them from reattaching. The dusting powder 60 is not harmful to honey bees, and as such, applying the dusting powder 60 to honey bees provides a practical means of eliminating varroa mites without disrupting the natural behavior of the honey bees. In an alternative embodiment, the dusting powder 60 further comprises carnauba wax.

While the above description contains specific details regarding certain elements, sizes, and other teachings, it is understood that embodiments of the invention or any combination of them may be practiced without these specific details. Specifically, although weights and ratios are designated in the above embodiments, any suitable weight and ratio may be used. These details should not be construed as limitations on the scope of any embodiment, but merely as exemplifications of the presently preferred embodiments. In other instances, well-known structures, elements, and techniques have not been shown to clearly explain the details of the invention.

We claim:

1. A honey bee mite removal device comprising:
a chamber comprising a one-way entry gate opposing an exit gate;
an electronics puck positioned within said chamber;
fondant positioned within said chamber, said fondant configured to entice honey bees to enter said chamber through said one-way entry gate; and
a dusting assembly positioned within said chamber and adjacent to said exit gate, said dusting assembly configured to dispense dusting powder onto said honey bees;
wherein said honey bees will groom themselves when said dusting powder is dispensed, dislodging any mites that are attached to said honey bees.

2. The honey bee mite removal device of claim 1, wherein said dusting assembly further comprises a hopper, said hopper configured to retain said dusting powder.

3. The honey bee mite removal device of claim 2, wherein said dusting assembly further comprises a vibration motor in mechanical communication with said hopper, wherein said vibration motor agitates said hopper and dispenses said dusting powder onto said honey bees.

4. The honey bee mite removal device of claim 3, wherein said dusting assembly further comprises a hopper saddle and filter, wherein said is a mesh disc positioned between said hopper and said hopper saddle, wherein said dusting powder is dispensed through said filter and onto said honey bees.

5. The honey bee mite removal device of claim 3, wherein said electronics puck is in electrical communication with said vibration motor and wherein said electronics puck further comprises a plurality of sensors configured to detect if a honey bee is positioned within said dusting assembly and further configured to activate said vibration motor when said honey bee is detected within said dusting assembly.

6. The honey bee mite removal device of claim 3, wherein said electronics puck further comprises a plurality of solar panels in electrical communication with a battery, wherein said solar panels and said battery provide power to said electronics puck and said vibration motor.

7. The honey bee mite removal device of claim 1, wherein said electronics puck further comprises a plurality of sensors configured to monitor honey bee activity within said device and store said honey bee activity as usage data, said electronics puck further configured to wirelessly transfer said usage data with an external mobile application.

8. The honey bee mite removal device of claim 7, wherein said external mobile application further comprises usage data, battery data, dusting powder replacement warnings, fondant replacement warnings, and maintenance warnings.

9. The honey bee mite removal device of claim 1, wherein said chamber further comprises a mesh floor, said mesh floor further comprising a plurality of apertures configured to let mites and excess dusting powder fall from the device as said honey bees groom themselves.

10. The honey bee mite removal device of claim 1, wherein said chamber further comprises an access door for providing access to the chamber, wherein said access door further comprises a hinge, wherein said access door is rotatably attached to said chamber through said hinge.

11. The honey bee mite removal device of claim 10, wherein said access door further comprises a pair of magnets and wherein said chamber further comprises a pair of opposing magnets, wherein said pair of magnets are configured to magnetically attach to said pair of opposing magnets to maintain said access door in a closed position.

12. The honey bee mite removal device of claim 1, wherein said one-way entry gate further comprises an aperture at its center surrounded by ultraviolet paint for enticing said honey bees into said one-way entry gate.

13. The honey bee mite removal device of claim 1, wherein said dusting powder further comprises wax and essential oils in powder form and wherein said dusting assembly is configured to dispense between 3-5 milligrams of dusting powder.

14. The honey bee mite removal device of claim 13, wherein said essential oils further comprise rosemary, cinnamon, or lemongrass.

15. The honey bee mite removal device of claim 1, wherein said dusting powder further comprises a size between 100-300 microns.

16. The honey bee mite removal device of claim 1, wherein said fondant further comprises glycerin, sugar, and water and has a solid consistency.

17. The honey bee mite removal device of claim 16, wherein said fondant further comprises essential oils.
